(19) United States
(12) Patent Application Publication
(10) Pub. No.: US 2020/0410390 A1
(43) Pub. Date: Dec. 31, 2020

(54) MACHINE LEARNING RETRAINING

(71) Applicant: MICROSOFT TECHNOLOGY LICENSING, LLC., REDMOND, WA (US)

(72) Inventors: SHENGYU FU, REDMOND, WA (US); SIMON CALVERT, SAMMAMISH, WA (US); JONATHAN DANIEL KEECH, KIRKLAND, WA (US); KESAVAN SHANMUGAM, REDMOND, WA (US); NEELAKANTAN SUNDARESAN, BELLEVUE, WA (US); MARK ALISTAIR WILSON-THOMAS, MERCER ISLAND, WA (US)

(21) Appl. No.: 16/452,825

(22) Filed: Jun. 26, 2019

(51) Int. Cl. G06N 20/00

(52) U.S. Cl. CPC G06N 20/00

(57) ABSTRACT

The behavior of a machine learning model and the training dataset used to train the model are monitored to determine when the accuracy of the model's predictions indicate that the model should be retrained. The retraining is determined from one or more precision metrics and a coverage metric that are generated during operation of the model. A precision metric measures the ability of the model to make predictions that are accepted by an inference system and the coverage metric measures the ability of the model to make predictions given a set of input features. In addition, changes made to the training dataset are analyzed and used as an indication of when the model should be retrained.

### BACKGROUND

A machine learning model is a mathematical representation of a real-world process. A machine learning model is usually trained using a mathematical function on historical usage data of a target process. The model may be trained using different types of machine learning algorithms, such as supervised learning, semi-supervised learning, unsupervised learning, and reinforcement learning. In supervised learning, the mathematical function (e.g., linear regression, logistic regression, random forest, decision tree, K-nearest neighbors, etc.) learns from patterns in the data that generate an outcome in order to associate relationships between the historical usage data and an outcome. In unsupervised learning, the mathematical function (e.g., K-means cluster analysis, etc.) learns from patterns in the data without an output label or classification. Semi-supervised learning uses historical usage data that may not have an outcome. Reinforcement learning uses past experiences through trial and error to perform the best solution of a target problem.

The model is often used to make predictions from the learned patterns. The model is useful when the model makes accurate predictions. The accuracy of the model is based on the training dataset used to train the model. The training dataset should closely reflect the types of data that may be used in the real-world process and have a similar distribution to the data that is used in the real-world process. However, at times, the training dataset may differ from the data used in the real-world process which may adversely affect the accuracy of the predictions made by the machine learning model.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The behavior of a machine learning model and the dataset used to train the model are monitored to determine whether a machine learning model requires retraining. The accuracy of the predictions made by a machine learning model may degrade over time. The degradation of the model to produce accurate results is determined from the performance metrics generated during operation of the machine learning model. The performance metrics capture the successful use of the model and the failure of the model to recognize input features. A precision metric is computed that is based on a number of times predictions made by the model are used. The precision metric identifies when the model does not represent the input features of a target application thereby indicating that the model should be retrained with more relevant training data. A coverage metric is computed that is based on a number of times the model is not able to make predictions for input features of a target application thereby indicating that the model should be retrained with more relevant training data.

Changes to the training dataset overtime may contribute to the staleness of the data used to train the model. In this case, the training dataset is monitored to determine when significant changes have been made to the training dataset. The training dataset is monitored to track the amount and nature of the changes made to the training data after the model was trained. A change metric is generated to determine whether the training data has been altered significantly indicating a possible factor to the degradation of the model.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system having a machine learning model retraining subsystem.

FIG. 2 is a schematic diagram illustrating an exemplary application of the retraining detection technique applied to a code completion system.

FIG. 3 is a flow diagram illustrating an exemplary method to determine when a machine learning model should be retrained.

FIG. 4 is a flow diagram illustrating an exemplary method to determine code churn as a metric to indicate retraining the machine learning model.

FIG. 5 is a block diagram illustrating an exemplary operating environment.

### DETAILED DESCRIPTION

Overview

The subject matter disclosed identifies in real-time when a machine learning model should be retrained. The training of a machine learning model is often a complicated task requiring a considerable amount of time and computing resources making it impractical to retrain the model frequently. The model may need to be retrained when the model does not make accurate predictions or cannot make predictions for certain inputs. This may be attributable to the model having been trained on stale data that does not reflect the characteristics of a target inference system.

In order to detect the staleness of a machine learning model, the techniques disclosed herein generate online metrics that are used to determine the effectiveness of a machine learning model. A precision metric is generated to detect the accuracy of the model's predictions. A coverage metric is generated to detect when the machine learning model is failing to make predictions. A data source metric is generated to detect when significant changes have been made to the training dataset. When either of these metrics falls below a pre-configured threshold, an indicator is generated that recommends that the machine learning model should be retrained.

The disclosure is presented using an exemplary code completion inference system to illustrate the techniques employed. However, it should be noted that the techniques described herein is not limited to a code completion system. Code completion is an automatic process of predicting the rest of a code fragment as the user is typing in a source code editor. Code completion speeds up the code development time by generating candidates to complete a code fragment when it correctly predicts the name of a program element that a user intends to enter after a few characters have been typed. A code completion system may utilize a machine learning model that predicts the most likely candidates to complete a code fragment.

However, when the machine learning model fails to make accurate predictions, the model needs to be retrained. The failure of the model may be attributable to the staleness of the training dataset. This is recognized by monitoring the performance of the model and by monitoring changes made to the training dataset after the model has been trained.

Attention now turns to a further discussion of the system, devices, components, and methods utilized to determine when to retrain a machine learning model.

Machine Learning Retraining System

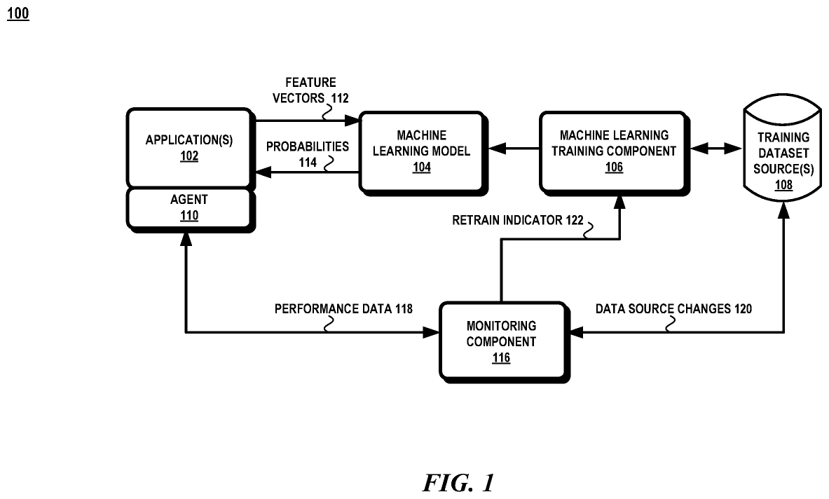

FIG. 1 illustrates a block diagram of an exemplary system 100 in which various aspects of the invention may be practiced. As shown in FIG. 1, system 100 includes one or more applications 102 that utilize a machine learning model 104 in an inference system. The machine learning model 104 is trained by a machine learning training component 106 using a training dataset from one or more sources 108. An application 102 may generate feature vectors 112 that are input into the machine learning model 104. A feature vector 112 contains features representing characteristics of an observation being studied. In turn, the machine learning model 104 generates a probability for each feature 114 which is used to predict a likelihood of a feature being associated with an outcome. The machine learning model 104 may be based on any type of statistical method, such as without limitation, Markov model, neural network, classifier, decision tree, random forest, regression model, cluster-based models, and the like.

An application 102 may be communicatively coupled to an agent 110. The agent 110 may be a software program such as an add-on, extension, plug-in, or component of the application. The agent 110 monitors the communications between the application 102 and the machine learning model 104. The agent 110 generates counts from these communications which are used by a monitoring component 116 to generate performance data 118. The performance data 118 reflects the performance of the model 104 and are used to determine whether or not the machine learning model 104 needs to be retrained.

The monitoring component 116 also monitors the changes made to the training dataset 108 since the model was last trained. These data source changes 120 are used to determine the staleness of the training data which is an indicator that the model needs to be retrained.

The monitoring component 116 outputs a retrain indicator 122 which when set indicates that the machine learning model 104 needs to be retrained. The retrain indicator 122 is set based on the performance data 118 and the data source changes 120. Upon the machine learning training component 106 receiving the retrain indicator 122, the machine learning training component 106 retrains the model. The machine learning training component 106 retrains the model using additional training data or new training data from one or more sources 108. An updated model is generated and used in the target inference system.

It should be noted that FIG. 1 shows components of the system in one aspect of an environment in which various aspects of the invention may be practiced. However, the exact configuration of the components shown in FIG. 1 may not be required to practice the various aspects and variations in the configuration shown in FIG. 1 and the type of components may be made without departing from the spirit or scope of the invention.

Code Completion System

Attention now turns to a discussion of an exemplary code completion system utilizing the techniques described herein. Code completion is an automatic process of predicting the rest of a code fragment as the user is typing in a source code editor or editing tool. Code completion speeds up the code development time by generating candidates to complete a code fragment when it correctly predicts the name of a program element that a user intends to enter after a few characters have been typed. A code completion system may utilize a machine learning model that predicts the most likely candidates or recommendations to complete a code fragment.

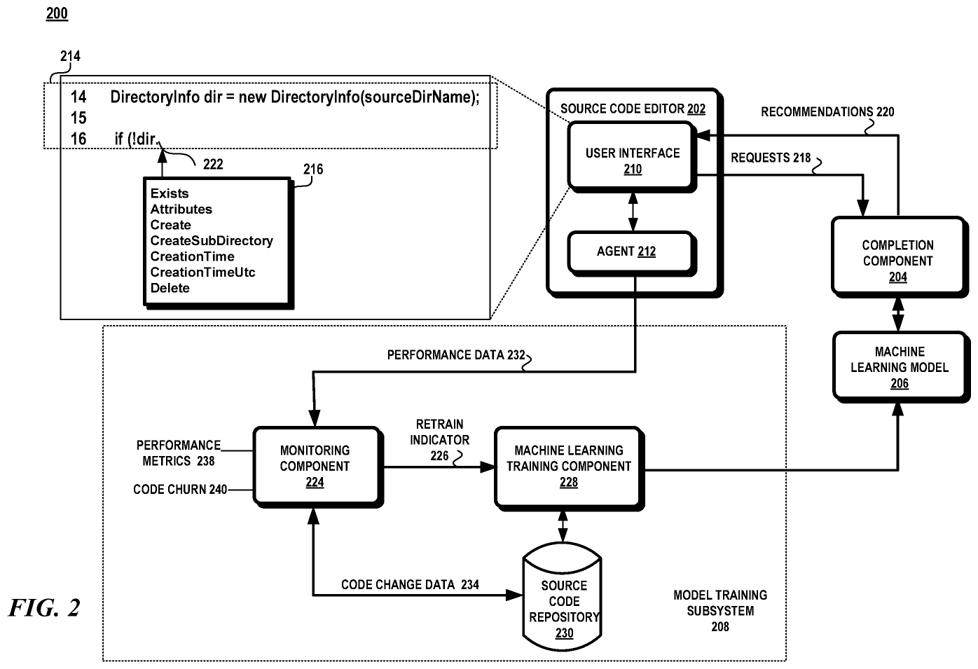

Turning to FIG. 2, there is shown an exemplary code completion system 200. The code completion system 200 may include a source code editor 202, a completion component 204, a machine learning model 206, and a model training subsystem 208.

The source code editor 202 may include a user interface 210 that interacts with a user and an agent 212 that interacts with the model training subsystem 208. In one or more aspects, code completion may be a function or feature integrated into a source code editor and/or integrated development environment (IDE). Code completion may be embodied as a tool or feature that can be an add-on, plug-in, extension and/or component of a source code editor and/or IDE.

The user interface 210 includes a set of features or functions for writing and editing a source code program 214. The user interface 210 may utilize a pop-up window 216 to present a list of possible recommendations or candidates for completion thereby allowing a developer to browse through the candidates and to select one from the list.

At certain points in the editing process, the user interface 210 will detect that the user has entered a particular input or marker character which will initiate the code completion process. In one aspect, a period “.” after an object name is used to initiate code completion for a method name that completes a method invocation. The completion component 204 receives requests 218 for candidates to complete the method invocation. The completion component 204 utilizes the machine learning model 206 for recommendations 220 to complete the method invocation based on the context of the method invocation.

The recommendations 220 are listed in a ranked order with the method name having the highest probability listed first. The ranked order increases recommendation relevance. The recommendations 220 are returned back to the user interface 210 which in turn provides the recommendations 220 to the user.

As shown in FIG. 2, a user types in a marker character 222 in source code editor 202 indicating that a method name is expected after an object name. In this example, the marker character 222 is a period, “.”, which is after the object name, dir. A request 218 is generated and sent to the completion component 204 which returns several recommendations 220 that are displayed in a pop-up window 216 in the user interface 210. The recommendations include “Exists”, “Attributes”, “Create”, “CreateSubDirectory”, “CreationTime”, “CreationTimeUtc”, and “Delete.”

The model training subsystem 208 includes a monitoring component 224, a machine learning training component 228 and a source code repository 230 from which the training dataset was obtained. The machine learning training component 228 trains the machine learning model initially and retrains the model when instructed by the monitoring component 224.

The source code repository 230 is part of a source control system or version control system implemented as a file archive and optionally a web hosting facility that stores large amounts of artifacts, such as source code files. Programmers (i.e., developers, users, end users, etc.) often utilize a shared source code repository to store source code and other programming artifacts that can be shared among different programmers. A programming artifact is a file that is produced from a programming activity, such as source code, program configuration data, documentation, and the like. The source control system or version control system stores each version of an artifact, such as a source code file, and tracks the changes or differences between the different versions. Repositories managed by source control systems may be distributed so that each user of the repository has a working copy of the repository. The source control system coordinates the distribution of the changes made to the contents of the repository to the different users.

In one aspect, the version control system is implemented as a cloud or web service that is accessible to various programmers through online transactions over a network. An online transaction or transaction is an individual, indivisible operation performed between two networked machines. A programmer may check out an artifact, such as a source code file, and edit a copy of the file in its local machine. When the user is finished with editing the source code file, the user performs a commit which checks in the modified version of the source code file back into the shared source code repository.

A source code repository 230 may be privately accessible or publicly accessible. There are various types of version control systems, such as without limitation, Git, and then platforms hosting version control systems such as Bitbucket, CloudForge, ProjectLocker, GitHub, SourceForge, Launchpad, Azure DevOps.

In one aspect, Git or GitHub is used as the exemplary source code repository. In this aspect, a commit is a change to a file or set of files and has a unique identifier associated with it. A commit contains a commit message that includes the changes that were made to the file or files. A diff is the difference between two commits or saved changes. A diff describes the changes added or removed from a file since the last commit. Commits and diffs are used to determine changes made to a source code repository since the machine learning model was last trained.

The machine learning training component 228 trains the machine learning model on usage patterns found in commonly-used source code programs in the source code repository 230. The usage patterns are detected from the characteristics of the context in which a method invocation is used in a program. These characteristics are extracted from data structures representing the syntactic structure and semantic model representations of a program. A machine learning model is generated for each class and contains ordered sequences of method invocations with probabilities representing the likelihood of a transition from a particular method invocation sequence to a succeeding method invocation. In one aspect, the machine learning model is an n-order Markov chain model which is used to predict what method will be used in a current invocation based on preceding method invocations of the same class in the same document and the context in which the current method invocation is made.

The monitoring component 224 monitors the usage of the model by an intended application and the changes made to the training dataset in order to determine if the model needs to be retrained. An agent 212 coupled to the source code editor 202 monitors the requests 218 made to the completion component 204 and the recommendations 220 returned from the completion component 204 to generate performance data 232 representative of the machine learning model's performance. The monitoring component 224 generates the performance metrics 238 and sets the retrain indicator 226 when at least one of the performance metrics falls below a threshold.

The monitoring component 224 obtains code change data 234 from the source code repository 230 in order to determine the code churn 240 of the repository 230. Code churn is a measurement that indicates the rate at which the source code in the source code repository changes. The monitoring component 224 determines if the code churn exceeds a threshold and when this occurs, the monitoring component 224 sets the retrain indicator 226. When the retrain indicator 226 is set, the machine learning training component 228 obtains new and/or additional data from the source code repository 230 to retrain the model. An updated model is then utilized by the completion component 204.

Methods

Attention now turns to a description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

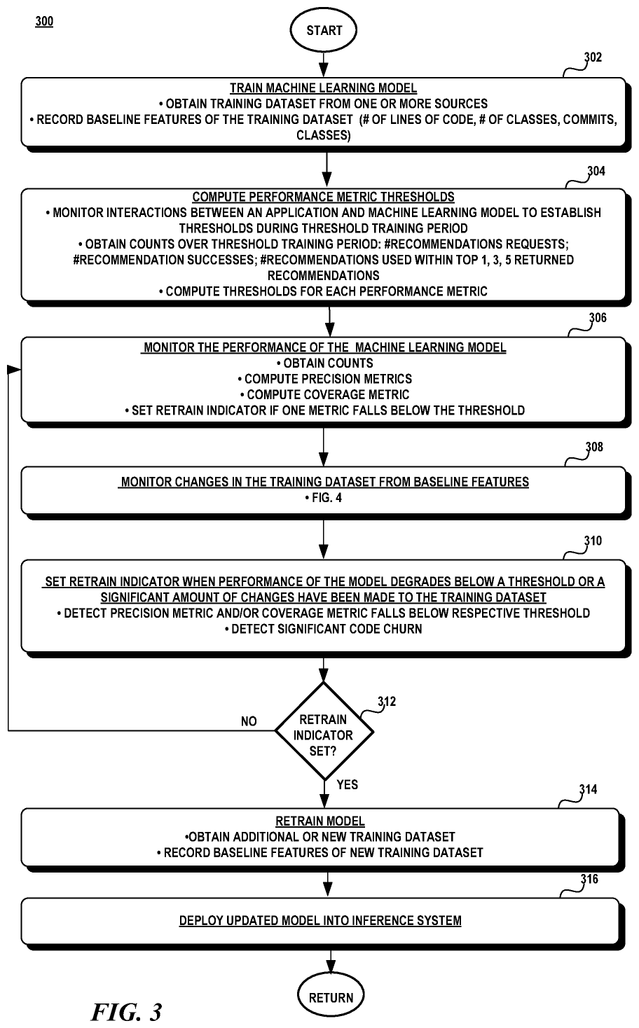

Referring to FIGS. 2 and 3, there is shown an exemplary method 300 for detecting the staleness of a machine learning model. Initially, the machine learning model 206 is trained, by the machine learning training component 228, using the source code programs, written in the same programming language, from one or more source code repositories 230. These source code programs are used as the training dataset. Data from the initial training dataset is recorded in order to detect changes that are made to the initial training data after the model is trained. This recorded data may include the commits associated with the initial training data, the number of lines of source code of each file in the training dataset, and/or the number of classes in the training dataset. These recorded features are used at a later point in time to determine the code churn of the training dataset. (Collectively, block 302).

The thresholds for the performance metrics 238 are computed from monitoring the interactions between the source code editor 202 and the machine learning model 206 during a threshold training period. The source code editor 202 requests recommendations 220 from the machine learning model 206 to complete a code fragment. An agent 212 coupled to the source code editor 202 monitors the communications between the source code editor 202 and the machine learning model 206. The agent 212 may track the number of times the source code editor 202 requests recommendations 220 from the completion component 204, the number of recommendations 220 returned from the completion component 204, and the number of recommendations 220 that are utilized by the source code editor 202 within the threshold training period. The monitoring component 224 uses the counts from the threshold training period to generate a threshold for each performance metric from which the performance of the model is analyzed (Collectively, block 304).

In one aspect, the threshold training period for may consist of thirty days. During this threshold training period, the agent 212 may compute counts that include the total number of requests 218 that the application makes to the completion component 204, the total number of recommendations that are returned from the completion component 204, the number of recommendations that are used by the application where an accepted recommendation is within the top 1, 3, or 5 recommendations that were returned to the application (Collectively, block 304).

The counts are transmitted to the monitoring component 224 which computes the thresholds. There is a threshold for the precision and coverage metrics. There may be multiple precision metrics based on the rank of an accepted recommendation. In one aspect, the metrics and thresholds may be computed as follows:

$$\begin{matrix}Precision ( Top 1 ) = \frac{\begin{matrix}Number of first - \\ ranked recommendations that were accepted\end{matrix}}{Total number of recommendations made by the model} , & ( 1 ) \\ Precision ( Top 3 ) = \frac{ \begin{matrix}Number of top 3 ranked \\ recommendations that were accepted \end{matrix}}{Total number of recommendations made by the model} , & ( 2 ) \\ Precision ( Top 5 ) = \frac{\begin{matrix}Number of top 5 ranked \\ recommendations that were accepted\end{matrix}}{Total number of recommendations made by the model} , & ( 3 ) \\ Coverage = \frac{Total number of recommendations returned by the model}{ \begin{matrix}Total number of recommendation \\ requests made by the application\end{matrix}} , & ( 4 )\end{matrix}$$

Precision (Top 1) Threshold=μ[Precision (Top 1)]−2*σ[Precision (Top 1)],

Precision (Top 3) Threshold=μ[Precision (Top 3)]−2*σ[Precision (Top 3)],

Precision (Top 5) Threshold=μ[Precision (Top 5)]−2*σ[Precision (Top 5)],

Coverage Threshold=μ[Coverage]−2*σ[Coverage].

In one aspect, the probabilities computed by the model are used to rank the recommendations in a descending order from the recommendation having the highest probability to the recommendation having the lowest probability. The recommendation having the highest probability is considered the Top 1 recommendation, recommendations with the three highest probabilities are considered the Top 3 recommendations, and recommendations having the five highest probabilities are considered the Top 5 recommendations.

The Precision (Top 1) metric represents the ratio of the number of Top 1 recommendations that were used by the application over the total number of recommendations made by the machine learning model. The Precision (Top 3) metric represents the ratio of the number of Top 3 recommendations that were used by the application over the total number of recommendations made by the machine learning model. The Precision (Top 5) metric represents the ratio of the number of Top 5 recommendations that were used by the application over the total number of recommendations made by the machine learning model.

The Precision (Top 1) Threshold is computed as the mean, μ, of the Precision (Top 1) metrics over the threshold training period less twice the standard deviation, σ, of the Precision (Top 1) metrics. The Precision (Top 3) Threshold is computed as the mean, μ, of the Precision (Top 3) metrics over the threshold training period less twice the standard deviation, σ, of the Precision (Top 3) metrics. Likewise, Precision (Top 5) Threshold is computed as the mean, μ, of the Precision (Top 5) metrics over the threshold training period less twice the standard deviation, σ, of the Precision (Top 5) metrics. The Coverage Threshold is computed similarly as the mean, μ, of the Coverage metrics over the threshold training period less twice the standard deviation, σ, of the Coverage metrics. (Collectively, block 304).

Once the thresholds are established, the agent 212 monitors the communications between the source code editor 202 and the completion component 204 during a target time period. The target time period may be a predetermined length of time or defined as the duration that the source code editor 202 executes a determined number of times. During this target time period, the agent 212 provides counts, such as the number of times that the application requests recommendations from the completion component 204, the number of times the model returns at least one recommendation to the application, the number of times a Top 1 recommendation is selected by the application, the number of time a Top 3 recommendation is selected by the application, and the number of times a Top 5 recommendation is selected by the application. (Collectively, block 306).

The monitoring component 224 receives the counts and computes the precision and coverage metrics (1)-(4) from these counts. The monitoring component 224 also determines if any one of the metrics falls below its respective threshold. When a metric is below its associated threshold, the monitoring component 224 sets the retrain indicator (Collectively, block 306).

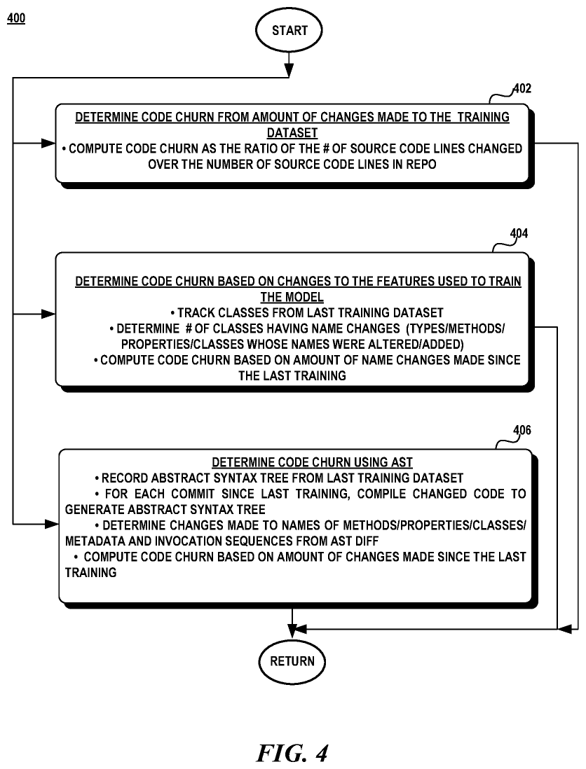

Additionally, the monitoring component 224 monitors the code churn of the training dataset (block 308). Turning to FIG. 4, there is shown three exemplary methods for computing the code churn of the training dataset in order to determine the staleness of the data used to train the model.

In a first aspect, the code churn is determined as a function of the amount of changes made to the training dataset since the last training of the model. The code churn may be computed as the ratio of the number of lines of source code that have changed in the source code repository over the total number of lines of source code in the source code repository. For a GIT-type source code repository, a search may be performed of the commits made to the source code repository since the model was previously trained. The commits that existed at the model was last trained are saved so that the differences may be determined. A diff command may be used to determine the differences between the latest commit and the commit saved at the time the model was last trained. The number of lines changed may be obtained from the diff which is then used to determine the code churn rate. (Collectively, block 402).

Alternatively, code churn may be computed based on the changes made to the features extracted from the source code programs that were used to train the model. In the case of the code completion example shown in FIG. 2, the model was trained on features that represented the context of a method invocation. The context of a method invocation may include one or more of the following: the spatial position of the method invocation in the program; whether the method call is inside a conditional statement (e.g., if-then-else program statement); the name of the class; the name of the method or property invoked; the name of the class corresponding to the invoked method; the function containing the method invocation; the type of the method; and an indication if the method is associated with an override, static, virtual, definition, abstract, and/or sealed keyword. (Collectively, block 404).

In this example, the source code text associated with a diff is analyzed to determine the nature of the changes made to the features used to train the model. Heuristics may be used to analyze the changes and to apply a weight to certain changes. For example, the classes from the previous training data may be tracked and used to determine if there were any name changes to a method, property, or class in the current version of the source code repository since the model was last trained. The amount of name changes may be compared to a threshold. The model would be retrained when the amount of name changes exceeded the threshold. (Collectively, block 404).

Alternatively, the code churn may be determined through a comparison that uses an abstract syntax tree (AST) representation of the source code. An AST is a syntax representation of the source code. The abstract syntax tree is a rooted n-ary tree where a non-leaf node corresponds to a non-terminal in the context-free grammar specifying structural information. A leaf node corresponds to a syntax token representing the program text.

The AST from the last training dataset was recorded. Each commit performed since the training phase is analyzed and the relevant source code is parsed or compiled into an AST. The ASTs recorded from the last training dataset is compared with the ASTs created from the recently-issued commits to determine the differences between the two ASTs, such as, if there were any significant changes (i.e., changes/additions/deletions) made to the name of the features (e.g., methods, properties, classes, types) used to train the model. In addition, the diffs or differences between the two ASTs may indicate changes made to the sequence of method invocations made in the program. The amount of these changes is then used to determine the code churn. When the amount of these changes exceeds a threshold, the model is then retrained. (Collectively, block 406).

Turning back to FIGS. 2 and 3, the monitoring component 224 sets the retrain indicator 226 when the precision metric or the coverage metric falls below a respective threshold or the code churn exceeds a corresponding threshold (block 310). For the code churn, the threshold may be a 5% increase of changes. However, the threshold may be altered based on the improvement or degradation in the performance of the model (block 310). The monitoring component 224 continues monitoring the performance of the model and the code churn of the training dataset (block 312—no). When the retrain indicator 226 is set (bock 312—yes), the model is retrained with the recently-changed training dataset, additional data or a new training dataset (bock 314). The baseline features of the new training dataset are stored to facilitate the continuous monitoring for code churn (block 314) and the retrained model is deployed into the target inference system (block 316).

Exemplary Operating Environment

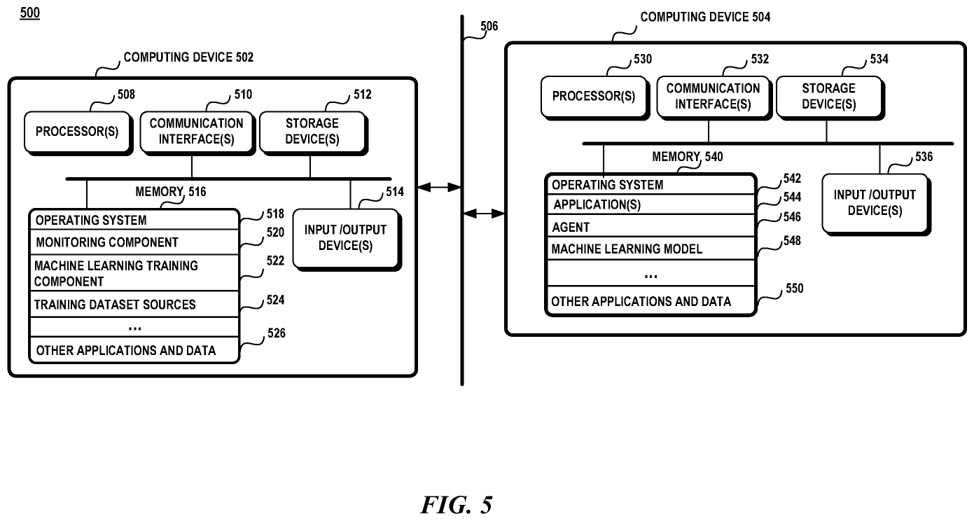

Attention now turns to a discussion of an exemplary operating environment. FIG. 5 illustrates an exemplary operating environment 500 in which a first computing device 502 is used to retrain the machine learning model and a second computing device 504 uses the machine learning model in a target inference system. However, it should be noted that the aspects disclosed herein is not constrained to any particular configuration of devices. Computing device 502 may utilize the machine learning model in its process and computing device 504 may generate and test machine learning models as well. Computing device 502 may be configured as a cloud service that retrains a machine learning model as a service for other code completion systems. The operating environment is not limited to any particular configuration.

The computing devices 502, 504 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, an Internet of Things (IoT), a network appliance, a web appliance, a distributed computing system, multiprocessor systems, or combination thereof. The operating environment 500 may be configured in a network environment, a distributed environment, a multi-processor environment, or a stand-alone computing device having access to remote or local storage devices.

The computing devices 502, 504 may include one or more processors 508, 530, one or more communication interfaces 510, 532, one or more storage devices 512, 534, one or more input/output devices 514, 536, and at least one memory or memory device 516, 540. A processor 508, 530 may be any commercially available or customized processor and may include dual microprocessors and multi-processor architectures. The communication interface 510, 532 facilitates wired or wireless communications between the computing device 502, 504 and other devices. A storage device 512, 534 may be computer-readable medium that does not contain propagating signals, such as modulated data signals transmitted through a carrier wave. Examples of a storage device 512, 534 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 512, 534 in the computing devices 502, 504. The input/output devices 514, 536 may include a keyboard, mouse, pen, voice input device, touch input device, display, speakers, printers, etc., and any combination thereof.

A memory 516, 540 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 516, 540 may also include one or more external storage devices or remotely located storage devices that do not pertain to propagated signals, such as modulated data signals transmitted through a carrier wave.

The memory 540 may contain instructions, components, and data. A component is a software program that performs a specific function and is otherwise known as a module, program, and/or application. The memory 540 may include an operating system 542, one or more applications 544, an agent 546, a machine learning model 548, and other applications and data 550. Memory 516 may include an operating system 518, a monitoring component 520, a machine learning training component 522, training dataset sources 524 and other applications and data 526.

The computing devices 502, 504 may be communicatively coupled via a network 506. The network 506 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 506 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

A system is disclosed having one or more processors, at least one memory device communicatively coupled to the one or more processors and one or more programs stored in the memory device. The one or more programs include instructions that: monitor operation of a machine learning model with a target application; generate a first metric that reflects an ability of the machine learning model to make a prediction given input features; generate a second metric that reflects usage of predictions made by the machine learning model; and when the first metric or the second metric falls below a threshold, retrain the machine learning model with a new training dataset.

The first metric represents a ratio of a number of predictions selected by the target application over a total number of predictions made by the machine learning model. The first metric represents a ratio of a number of times highest-ranked predictions selected by the target application over a total number of predictions made by the machine learning model. The second metric represents a ratio of a number of predictions made by the machine learning model over a total number of predictions made by the machine learning model.

The one or more programs include further instructions that: generate a first threshold for the first metric based on a plurality of first metrics made over a first time period, wherein the first threshold is within twice a standard deviation of a mean of the plurality of first metrics. Additional instructions generate a second threshold for the second metric based on a plurality of second metrics made over a second time period, wherein the second threshold is within twice a standard deviation of a mean of the plurality of the second metrics. Further instructions monitor changes made to a training dataset used to train the machine learning model after the machine learning model was last trained; and when the changes made to the training dataset have increased beyond a threshold, retrain the machine learning model with an updated training dataset.

The one or more programs include further instructions that: monitor code churn of the training dataset used to train the machine learning model since the model was last trained; and retrain the machine learning model when the code churn exceeds a threshold. Additional instructions perform actions that: measure the code churn as a ratio of a number of lines of source code changed in the training dataset over a number of lines of source code in the training dataset. Further instructions perform actions that measure the code churn based on an amount of changes made to features extracted from the last training dataset since last training. The one or more programs include further instructions that: detect the amount of changes made to the features extracted from the last training dataset using an abstract syntax tree representation of changes made since the last training.

A method is disclosed that comprises tracking, by a computing device having at least one processor and a memory, operation of a machine learning model with a target application; tracking changes made to a training dataset used to train the machine learning model since the machine learning model was last trained; and retraining the machine learning model with an updated training dataset, when operation of the machine learning model is below a first threshold or when a significant amount of changes have been made to the training dataset since the machine learning model was last trained exceeds a second threshold, wherein operation of the machine learning model is based on accuracy of predictions made by the machine learning model and ability of the machine learning model to make the predictions.

The method further comprises: computing a precision metric based on a ratio of an amount of predictions made by the machine learning model that are used by the target application over a total amount of predictions made by the machine learning model. The method further comprises: computing a coverage method based on a total number of predictions made by the machine learning model over a total number of requests made for predictions. The method performs additional actions comprising computing code churn as a measure of changes made to the training dataset, the code churn based on a number of lines of source code changed in the training dataset over a total number of lines of source code in the training dataset and computing code churn as a measure of changes made to the training dataset, the code churn based on name changes to features extracted from the training dataset, the features including a method, class and/or property extracted from the training dataset.

A device is disclosed that includes at least one processor coupled to at least one memory device. The at least one processor configured to: train a machine learning model based on an initial training dataset; utilize the machine learning model in an inference system; monitor code churn of the initial training dataset after the machine learning model was last trained; and upon the code churn exceeding a threshold, retrain the machine learning model with a second training dataset. Additionally, the at least one processor is further configured to: determine the code churn of the first training dataset as a function of a number of source code lines changes since the machine learning model was last trained. Furthermore, the at least one processor is further configured to: determine the code churn of the initial training dataset as a function of name changes made to features extracted from the initial training dataset. Yet additionally, the at least one processor is further configured to: determine the code churn of the initial training dataset as a function of changes detected from a syntactic representation of source code in the initial training dataset.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
one or more processors;
at least one memory device communicatively coupled to the one or more processors; and
one or more programs, wherein the one or more programs are stored in the memory device and configured to be executed by the one or more processors, the one or more programs including instructions that:
monitor operation of a machine learning model with a target application;
generate a first metric that reflects an ability of the machine learning model to make a prediction given input features;
generate a second metric that reflects usage of predictions made by the machine learning model; and
when the first metric or the second metric falls below a threshold, retrain the machine learning model with a new training dataset.

2. The system of claim 1, wherein the first metric represents a ratio of a number of predictions selected by the target application over a total number of predictions made by the machine learning model.

3. The system of claim 1, wherein the first metric represents a ratio of a number of times highest-ranked predictions are selected by the target application over a total number of predictions made by the machine learning model.

4. The system of claim 2, wherein the second metric represents a ratio of a number of predictions made by the machine learning model over a total number of predictions made by the machine learning model.

5. The system of claim 1, wherein the one or more programs include further instructions that:
generate a first threshold for the first metric based on a plurality of first metrics made over a first time period, wherein the first threshold is within twice a standard deviation of a mean of the plurality of first metrics.

6. The system of claim 1, wherein the one or more programs include further instructions that:
generate a second threshold for the second metric based on a plurality of second metrics made over a second time period, wherein the second threshold is within twice a standard deviation of a mean of the plurality of the second metrics.

7. The system of claim 1, wherein the one or more programs include further instructions that:
monitor changes made to a training dataset used to train the machine learning model after the machine learning model was last trained; and
when the changes made to the training dataset have increased beyond a threshold, retrain the machine learning model with an updated training dataset.

8. The system of claim 1, wherein the one or more programs include further instructions that:
monitor code churn of the training dataset used to train the machine learning model since the model was last trained; and
retrain the machine learning model when the code churn exceeds a threshold.

9. The system of claim 8, wherein the one or more programs include further instructions that:
measure the code churn as a ratio of a number of lines of source code changed in the training dataset over a number of lines of source code in the training dataset.

10. The system of claim 8, wherein the one or more programs include further instructions that:
measure the code churn based on an amount of changes made to features extracted from the last training dataset since last training.

11. The system of claim 10, wherein the one or more programs include further instructions that:
detect the amount of changes made to the features extracted from the last training dataset using an abstract syntax tree representation of changes made since the last training.

12. A method, comprising:
tracking, by a computing device having at least one processor and a memory, operation of a machine learning model with a target application;
tracking changes made to a training dataset used to train the machine learning model since the machine learning model was last trained; and
retraining the machine learning model with an updated training dataset, when operation of the machine learning model is below a first threshold or when a significant amount of changes have been made to the training dataset since the machine learning model was last trained exceeds a second threshold, wherein operation of the machine learning model is based on accuracy of predictions made by the machine learning model and ability of the machine learning model to make the predictions.

13. The method of claim 12, further comprising:
computing a precision metric based on a ratio of an amount of predictions made by the machine learning model that are used by the target application over a total amount of predictions made by the machine learning model.

14. The method of claim 12, further comprising:
computing a coverage method based on a total number of predictions made by the machine learning model over a total number of requests made for predictions.

15. The method of claim 12, further comprising:
computing code churn as a measure of changes made to the training dataset, the code churn based on a number of lines of source code changed in the training dataset over a total number of lines of source code in the training dataset.

16. The method of claim 12, further comprising:
computing code churn as a measure of changes made to the training dataset, the code churn based on name changes to features extracted from the training dataset, the features including a method, class and/or property extracted from the training dataset.

17. A device, comprising:
at least one processor coupled to at least one memory device;
the at least one processor configured to:
train a machine learning model based on an initial training dataset;
utilize the machine learning model in an inference system;
monitor code churn of the initial training dataset after the machine learning model was last trained; and
upon the code churn exceeding a threshold, retrain the machine learning model with a second training dataset.

18. The device of claim 17, wherein the at least one processor is further configured to:
determine the code churn of the first training dataset as a function of a number of source code lines changes since the machine learning model was last trained.

19. The device of claim 17, wherein the at least one processor is further configured to:
determine the code churn of the initial training dataset as a function of name changes made to features extracted from the initial training dataset.

20. The device of claim 17, wherein the at least one processor is further configured to:
determine the code churn of the initial training dataset as a function of changes detected from a syntactic representation of source code in the initial training dataset.
